(19) United States
(12) Patent Application Publication
(10) Pub. No.: US 2013/0301142 A1
(43) Pub. Date: Nov. 14, 2013

(54) TELEPHOTO ZOOM LENS

(71) Applicants: SHENG-FANG CHENG, HSINCHU COUNTY (TW); SHIH-MU LIN, TAIPEI CITY (TW); YING-HSIN LIN, TAIPEI CITY (TW)

(72) Inventors: SHENG-FANG CHENG, HSINCHU COUNTY (TW); SHIH-MU LIN, TAIPEI CITY (TW); YING-HSIN LIN, TAIPEI CITY (TW)

(73) Assignee: A-OPTRONICS TECHNOLOGY INC., HSINCHU (TW)

(21) Appl. No.: 13/468,662

(22) Filed: May 10, 2012

(51) Int. Cl. G02B 15/14

(52) U.S. Cl. 359/687

(57) ABSTRACT

A telephoto zoom lens include a first, a second, a third and a fourth lens groups sequentially arranged along an optical axis and from an object side to an image side. The refractive powers of the four lens groups are positive, negative, positive and positive, respectively. The first lens group is fixed at a first predetermined position. The second lens group is movable along the optical axis depending on the variation of the magnifying power of the zoom lens. The third lens group is fixed at a second predetermined position. The fourth lens group is movable along the optical axis to keep an image plane generated by the zoom lens to project accurately onto an image sensor. Hence, the first and the third lens groups are in resting state, and the second and the fourth lens groups are movable during zoom-in or zoom-out operation of the zoom lens.

### BACKGROUND OF THE INVENTION

1. Field of the Invention

The instant disclosure relates to a telephoto zoom lens, and more particularly, to a telephoto zoom lens applied to a portable electronic device such as DV (digital video), DSC (digital still camera), tablet PC, etc. or applied to an image-capturing device such as CCTV (closed circuit television) camera, surveillance camera (safety, security, supervisory system), etc.

2. Description of Related Art

U.S. Pat. No. 7,532,411 discloses a zoom lens having 10× zoom ratio and including four lens groups that has positive, negative, positive and positive refractive powers (PNPP), respectively. However, the four lens groups need to be moved together to obtain a good image quality and the radius of the first lens group is the maximum one of the four lens groups, thus the energy consumption for moving the four lens groups are increased.

J.P Patent JP50-26931 discloses a zoom lens including five lens groups that has positive, negative, positive, negative and positive refractive powers (PNPNP), respectively. However, the second lens group and the fourth lens group need to be moved together to maintain the image on the same focal surface. In addition, J.P Patent JP45-08840 discloses a zoom lens including four lens groups that has positive, negative, positive and positive refractive powers (PNPP), respectively.

J.P Patent JP46-32989 discloses a zoom lens having 15× zoom ratio and including four lens groups that has positive, negative, negative and positive refractive powers (PNNP), respectively. In addition, U.S. Pat. No. 5,815,322 discloses a zoom lens having 20× zoom ratio and including four lens groups that has positive, negative, negative and positive refractive powers (PNNP), respectively. Moreover, U.S. Pat. No. 7,672,061 discloses a zoom lens having 22× zoom ratio and including four lens groups that has positive, negative, negative and positive refractive powers (PNNP), respectively. However, the PNNP refractive powers of the related arts are different from the PNPP refractive powers disclosed in the instant disclosure.

### SUMMARY OF THE INVENTION

One aspect of the instant disclosure relates to a telephoto zoom lens including four lens groups that has positive, negative, positive and positive refractive powers (PNPP), respectively.

One of the embodiments of the instant disclosure provides a telephoto zoom lens, comprising: a first lens group, a second lens group, a third lens group and a fourth lens group. The first lens group has a positive refractive power fixed at a first predetermined position. The second lens group has a negative refractive power being movable along an optical axis of the telephoto zoom lens in accordance with the change of the magnification of the telephoto zoom lens. The third lens group has a positive refractive power fixed at a second predetermined position. The fourth lens group has a positive refractive power being movable along the optical axis in order to keep an image plane generated by the telephoto zoom lens to project accurately onto an image sensor. The first, the second, the third and the fourth lens groups are arranged along the optical axis and from an object side of the telephoto zoom lens to an image side of the telephoto zoom lens in sequence, and the focal lengths of the first, the second and the third lens groups conform to the two following conditions:

$$6 < \vert \frac{F 1}{F 2} \vert < 10 and 2 < \vert \frac{F 1}{F 3} \vert < 3 ;$$

wherein F1 is the focal length of the first lens group, F2 is the focal length of the second lens group, and F3 is the focal length of the third lens group.

Therefore, the instant disclosure has some advantages, as follows:

1. The instant disclosure can provide an image capturing zoom lens having high zoom ratio, long focal length and high imaging quality.

2. The instant disclosure can create an image capturing zoom lens that has a suitable big aperture diameter of the first lens group and a 20× magnifying power.

To further understand the techniques, means and effects the instant disclosure takes for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention that they be used for limiting the instant disclosure.

### BRIEF DESCRIPTION OF THE DRAWINGS

FIG. 1A is a schematic view of the focal length of the telephoto zoom lens in wide-configuration according to the first embodiment of the instant disclosure;

FIG. 1B is a schematic view of the focal length of the telephoto zoom lens in normal-configuration according to the first embodiment of the instant disclosure;

FIG. 1C is a schematic view of the focal length of the telephoto zoom lens in tele-configuration according to the first embodiment of the instant disclosure;

FIG. 1D is a graph showing the longitudinal aberration (left), the field curvature (middle) and the distortion (right) of the telephoto zoom lens, when the focal length of the telephoto zoom lens is in wide-configuration according to the first embodiment of the instant disclosure;

FIG. 1E is a graph showing the longitudinal aberration (left), the field curvature (middle) and the distortion (right) of the telephoto zoom lens, when the focal length of the telephoto zoom lens is in normal-configuration according to the first embodiment of the instant disclosure;

FIG. 1F is a graph showing the longitudinal aberration (left), the field curvature (middle) and the distortion (right) of the telephoto zoom lens, when the focal length of the telephoto zoom lens is in tele-configuration according to the first embodiment of the instant disclosure;

FIG. 2A is a schematic view of the focal length of the telephoto zoom lens in wide-configuration according to the second embodiment of the instant disclosure;

FIG. 2B is a schematic view of the focal length of the telephoto zoom lens in normal-configuration according to the second embodiment of the instant disclosure;

FIG. 2C is a schematic view of the focal length of the telephoto zoom lens in tele-configuration according to the second embodiment of the instant disclosure;

FIG. 2D is a graph showing the longitudinal aberration (left), the field curvature (middle) and the distortion (right) of the telephoto zoom lens, when the focal length of the telephoto zoom lens is in wide-configuration according to the second embodiment of the instant disclosure;

FIG. 2E is a graph showing the longitudinal aberration (left), the field curvature (middle) and the distortion (right) of the telephoto zoom lens, when the focal length of the telephoto zoom lens is in normal-configuration according to the second embodiment of the instant disclosure; and

FIG. 2F is a graph showing the longitudinal aberration (left), the field curvature (middle) and the distortion (right) of the telephoto zoom lens, when the focal length of the telephoto zoom lens is in tele-configuration according to the second embodiment of the instant disclosure.

### DETAILED DESCRIPTION OF THE PREFERRED EMBODIMENTS

### First Embodiment

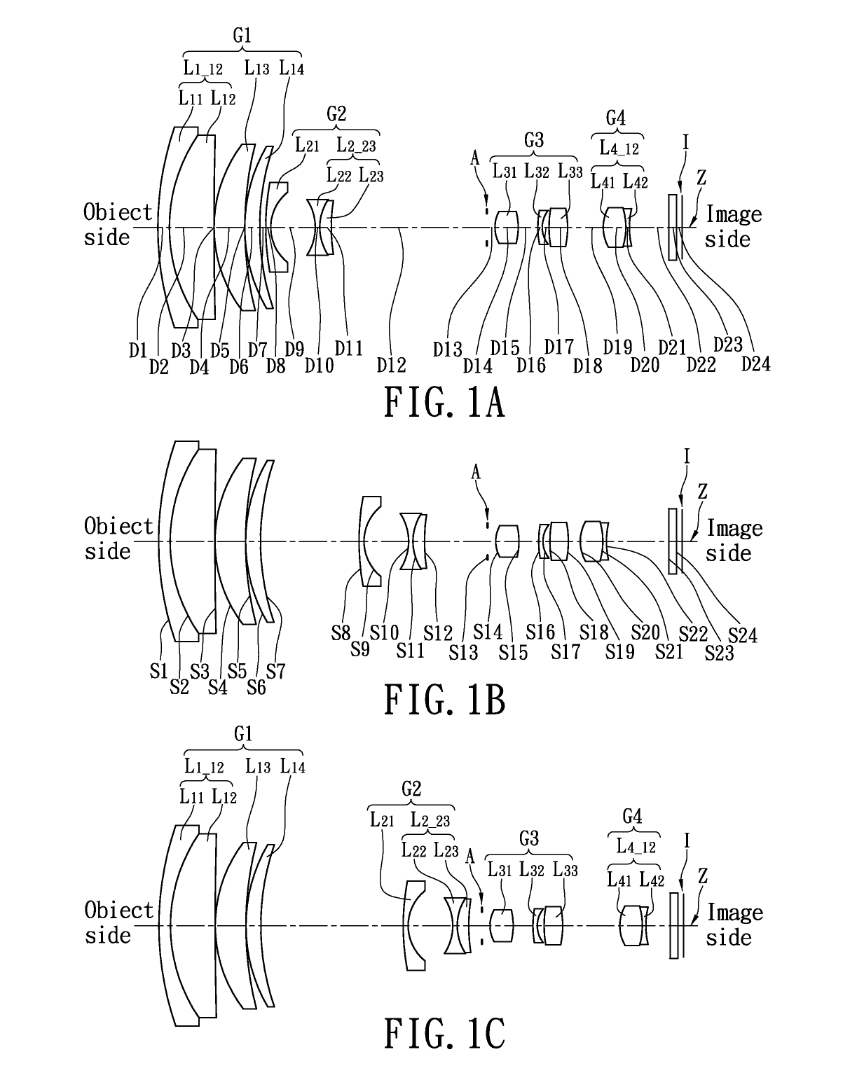

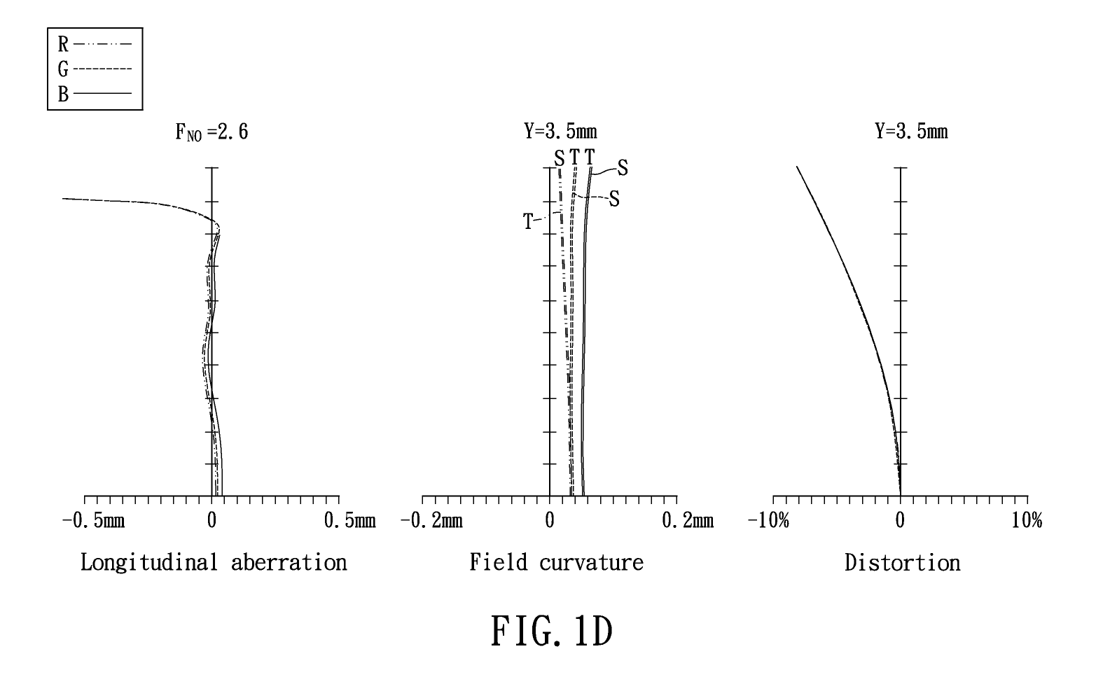

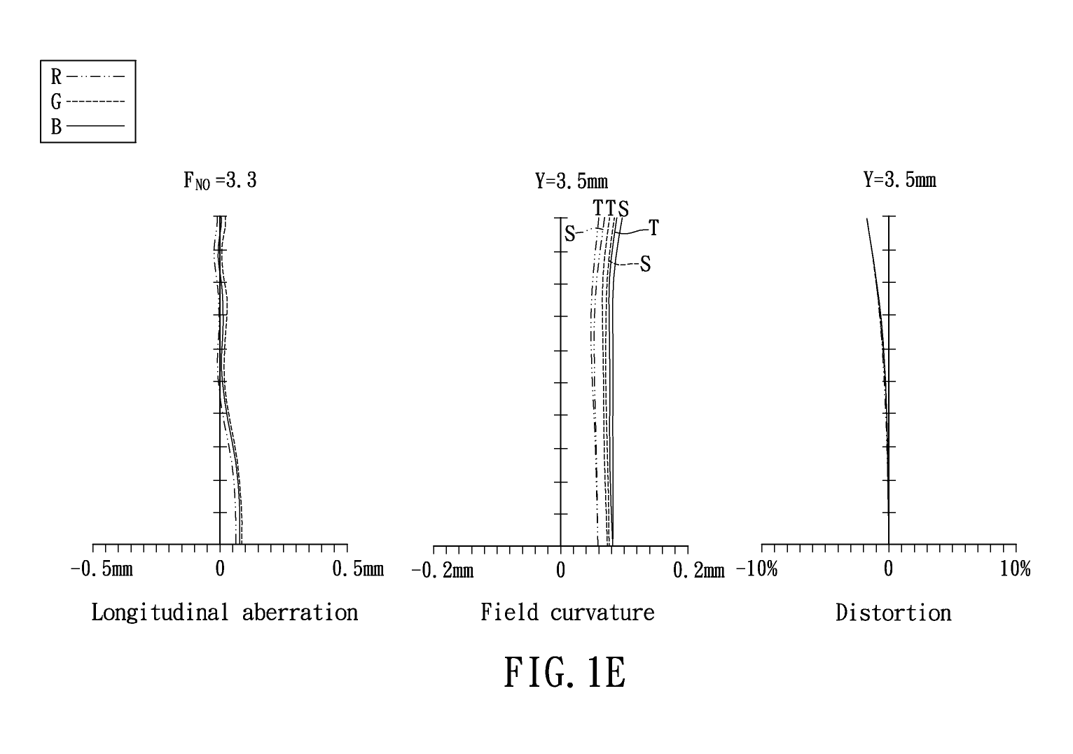

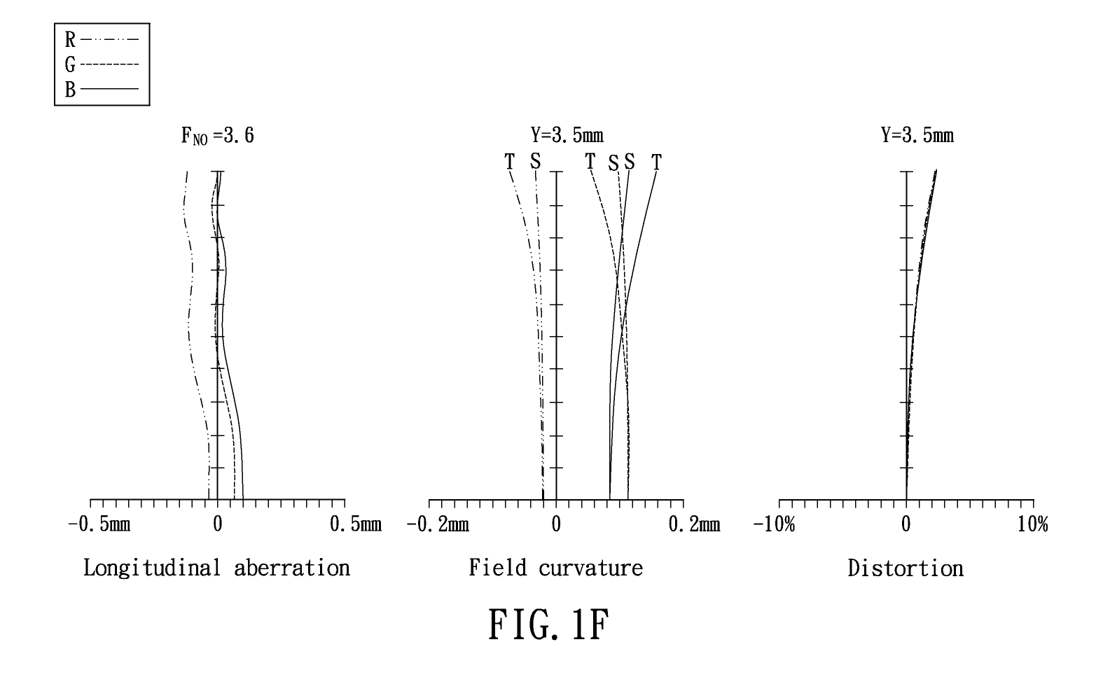

Referring to FIG. 1A to FIG. 1C, where FIG. 1A to FIG. 1C show schematic views of the focal length of the telephoto zoom lens in wide-configuration (as shown in FIG. 1A), normal-configuration (as shown in FIG. 1B) and tele-configuration (as shown in FIG. 1C) according to the first embodiment, respectively. The numbers D1-D24 in FIG. 1A are serial numbers of the distance between two optical surfaces of every two adjacent lenses, and the numbers S1-S24 in FIG. 1B are serial numbers of the optical surfaces of the lenses, respectively.

The telephoto zoom lens of the first embodiment may be composed of twelve pieces of lens and includes a first lens group G1, a second lens group G2, a third lens group G3 and a fourth lens group G4 as shown in FIGS. 1A to 1C. The refractive powers of the first lens group G1, the third lens group G3 and the fourth lens group G4 are positive, and refractive power of the second lens group G1 is negative. In addition, the focal length of the telephoto zoom lens is changeable according to the interval variation between any two lens groups arranged along the optical axis Z of the telephoto zoom lens.

In the preferred embodiment, the first lens group G1 may include a first lens L₁₁, a second lens L₁₂, a third lens L₁₃ and a fourth lens L₁₄ that may be arranged along the optical axis Z and from the object side to the image side of the telephoto zoom lens in sequence. The second lens group G2 may include a first lens L₂₁, a second lens L₂₂ and a third lens L₂₃ that may be arranged along the optical axis Z and from the object side to the image side of the telephoto zoom lens in sequence, and the second lens L₂₂ and the third lens L₂₃ can be combined to form a doublet lens L₂_{_{—}}₂₃. The third lens group G3 may include a first lens L₃₁, a second lens L₃₂ and a third lens L₃₃ that may be arranged along the optical axis Z and from the object side to the image side of the telephoto zoom lens in sequence. The fourth lens group G4 may include a first lens L₄₁ and a second lens L₄₂ that may be arranged along the optical axis Z and from the object side to the image side of the telephoto zoom lens in sequence, and the first lens L₄₁ and the second lens L₄₂ can be combined to form a doublet lens L₄_{_{—}}₁₂. In addition, the telephoto zoom lens has an aperture A arranged along the optical axis Z and between the second lens group G2 and the third lens group G3, and the diameter of the aperture A may be changeable.

In other words, the first lens group G1 has a positive refractive power fixed at a first predetermined position. The second lens group G2 has a negative refractive power being movable along the optical axis Z of the telephoto zoom lens in accordance with the change of the magnification of the telephoto zoom lens. The third lens group G3 has a positive refractive power fixed at a second predetermined position. The fourth lens group G4 has a positive refractive power being movable along the optical axis Z in order to keep an image plane generated by the telephoto zoom lens to project accurately onto an image sensor I. In addition, the first, the second, the third and the fourth lens groups (G1, G2, G3 and G4) are arranged along the optical axis and from the object side to the image side of the telephoto zoom lens in sequence.

For example, as follows:

(1) The focal lengths of the first, the second and the third lens groups (G1, G2, G3) conform to the two following conditions:

$$\begin{matrix}6 < \vert \frac{F 1}{F 2} \vert < 10 ; and & condition ( 1 ) \\ 2 < \vert \frac{F 1}{F 3} \vert < 3 ; & condition ( 2 )\end{matrix}$$

wherein F1 is the focal length of the first lens group G1, F2 is the focal length of the second lens group G2, and F3 is the focal length of the third lens group G3.

(2) The focal length of the first lens group G1 and the distance from the first lens group G1 to the third lens group G3 conform to the following condition:

$$1 < \vert \frac{F 1}{{d}_{1 - 3}} \vert < 1.2 ; \qquad condition ( 3 )$$

wherein F1 is the focal length of the first lens group G1, and d₁₋₃ is the distance from the first lens group G1 to the third lens group G3.

(3) The both the third lens L₁₃ and the fourth lens L₁₄ are a single meniscus lens, and the focal lengths of the third lens L₁₃, the fourth lens L₁₄ and the doublet lens L_{1 12} conform to the following condition:

$$2 < \vert {F}_{1 \_ 12} \times ( \frac{1}{{F}_{13}} + \frac{1}{{F}_{14}} ) \vert < 4 ; \qquad condition ( 4 )$$

wherein F₁₃ is the focal length of the third lens L₁₃ of the first lens group G1, F₁₄ is the focal length of the fourth lens L₁₄ of the first lens group G1, and F₁_{_{—}}₁₂ is the focal length of the doublet lens L₁_{_{—}}₁₂ of the first lens group G1.

(4) The first lens L₂₁ of the second lens group G2 is a single lens, and the focal lengths of the first lens L₂₁ of the second lens group G2 and the doublet lens L₂_{_{—}}₂₃ of the second lens group G2 conform to the following condition:

$$0.6 < \vert \frac{{F}_{21}}{{F}_{2 \_ 23}} \vert < 0.8 ; \qquad condition ( 5 )$$

wherein F₂₁ is the focal length of the first lens L₂₁ of the second lens group G2, and F₂_{_{—}}₂₃ is the focal length of the doublet lens L₂_{_{—}}₂₃ of the second lens group G2.

(5) The focal lengths of the third lens group G3 and the fourth lens group G4 conform to the following condition:

$$0.7 < \vert \frac{F 4}{F 3} \vert < 1.2 ; \qquad condition ( 6 )$$

wherein F3 is the focal length of the third lens group G3, and F4 is the focal length of the fourth lens group G4.

Referring to FIG. 1D to FIG. 1F, where FIG. 1D is a graph showing the longitudinal aberration (left), the field curvature (middle) and the distortion (right) of the telephoto zoom lens, when the focal length of the telephoto zoom lens is in wide-configuration according to the first embodiment, respectively. FIG. 1E is a graph showing the longitudinal aberration (left), the field curvature (middle) and the distortion (right) of the telephoto zoom lens in normal-configuration according to the first embodiment, respectively. FIG. 1F is a graph showing the longitudinal aberration (left), the field curvature (middle) and the distortion (right) of the telephoto zoom lens in tele-configuration according to the first embodiment, respectively.

The simulation data of the first embodiment are shown as the following table, where R shows curvature radius of the optical surface of each lens (serial numbers are shown from S1 to S24), D shows axial distance between two optical surfaces of every two adjacent lenses (serial numbers are shown from D1 to D24), n_{d} shows refractive index of the optical surface of each lens, and V_{d} shows Abbe number of the optical surface of each lens.

| | | | n_{d} | |
|---|---|---|---|---|
| | R (mm) | | (re- | V_{d} |
| surface | (curvature | D (mm) | fractive | (Abbe |
| number | radius) | (distance) | index) | number) |
| 1 | 108.02 | 2.40 | 1.92 | 18.9 |
| 2 | 55.89 | 9.10 | 1.70 | 55.5 |
| 3 | 716.05 | 0.20 | | |
| 4 | 48.71 | 6.00 | 1.75 | 52.3 |
| 5 | 107.89 | 0.22 | | |
| 6 | 57.96 | 3.00 | 1.77 | 49.6 |
| 7 | 91.85 | Variable | | |
| 8 | 88.84 | 1.00 | 1.88 | 40.8 |
| 9 | 14.40 | 9.20 | | |
| 10 | −18.60 | 0.91 | 1.73 | 54.7 |
| 11 | 16.96 | 2.64 | 1.92 | 18.9 |
| 12 | 109.37 | Variable | | |
| 13 | Infinity | 1.80 | | |
| 14 | 14.61 | 4.45 | 1.69 | 52.9 |
| 15 | −69.14 | 4.36 | | |
| 16 | 75.77 | 0.90 | 1.85 | 23.8 |
| 17 | 11.25 | 0.98 | | |
| 18 | 28.59 | 3.75 | 1.59 | 61.1 |
| 19 | −39.06 | Variable | | |
| 20 | 14.98 | 4.50 | 1.88 | 40.8 |
| 21 | −29.19 | 0.90 | 1.85 | 23.8 |
| 22 | 39.20 | Variable | | |
| 23 | Infinity | 1.00 | 1.52 | 64.1 |
| 24 | Infinity | 0.80 | | |

The focal length, the aperture value, the view angle and the variable distance D7, D12, D19 and D22 relative to different zoom position are shown as the following table:

| | Wide | Normal | Tele | Unit |
|---|---|---|---|---|
| f | 6.3 | 29 | 121 | mm |
| F_{NO} | 2.6 | 3.3 | 3.6 | |
| FOV(ω) | 29° | 6.8° | 1.65° | |
| D7 | 1.19 | 25.16 | 35.62 | mm |
| D13 | 37.08 | 13.11 | 2.65 | mm |
| D19 | 8.00 | 2.99 | 13.17 | mm |
| D22 | 8.11 | 13.12 | 2.94 | mm |

Where f is the system focal length in wide-configuration, normal-configuration and tele-configuration, F_{NO} is aperture value in wide-configuration, normal-configuration and tele-configuration, and FOV(ω) is view angle in wide-configuration, normal-configuration and tele-configuration.

Moreover, the optical surface S18 and S19 are aspherical surfaces, and the data of the aspherical surfaces are shown as the following table:

| Surface | K | A₄ | A₆ | A₈ | A₁₀ | A₁₂ | A₁₄ | A₁₆ |
|---|---|---|---|---|---|---|---|---|
| S18 | 5.16 | −3.13E−04 | 5.19E−06 | −3.03E−06 | 3.54E−07 | −1.97E−08 | 3.72E−10 | −8.65E−13 |
| S19 | 71.59 | −6.49E−05 | 8.13E−07 | −5.69E−07 | 4.22E−08 | −5.12E−10 | −1.04E−10 | 3.66E−12 |

In addition, the above-mentioned aspherical surfaces in the first embodiment are represented by the following expression:

$$Z = \frac{{CY}^{2}}{1 + \sqrt{( 1 - ( K + 1 ) {C}^{2} {Y}^{2}}} + {\sum }_{2}^{8} {A}_{2 n} {Y}^{2 n} ;$$

wherein Z is sag, C (=1/R) is the curvature of aspherical surface, K is the conic constant, Y is high vertical to the optical axis Z, A₄ is the 4^{th} aspherical coefficient, A₆ is the 6^{th} aspherical coefficient, and A₈ to A₁₆ may be deduced by analogy.

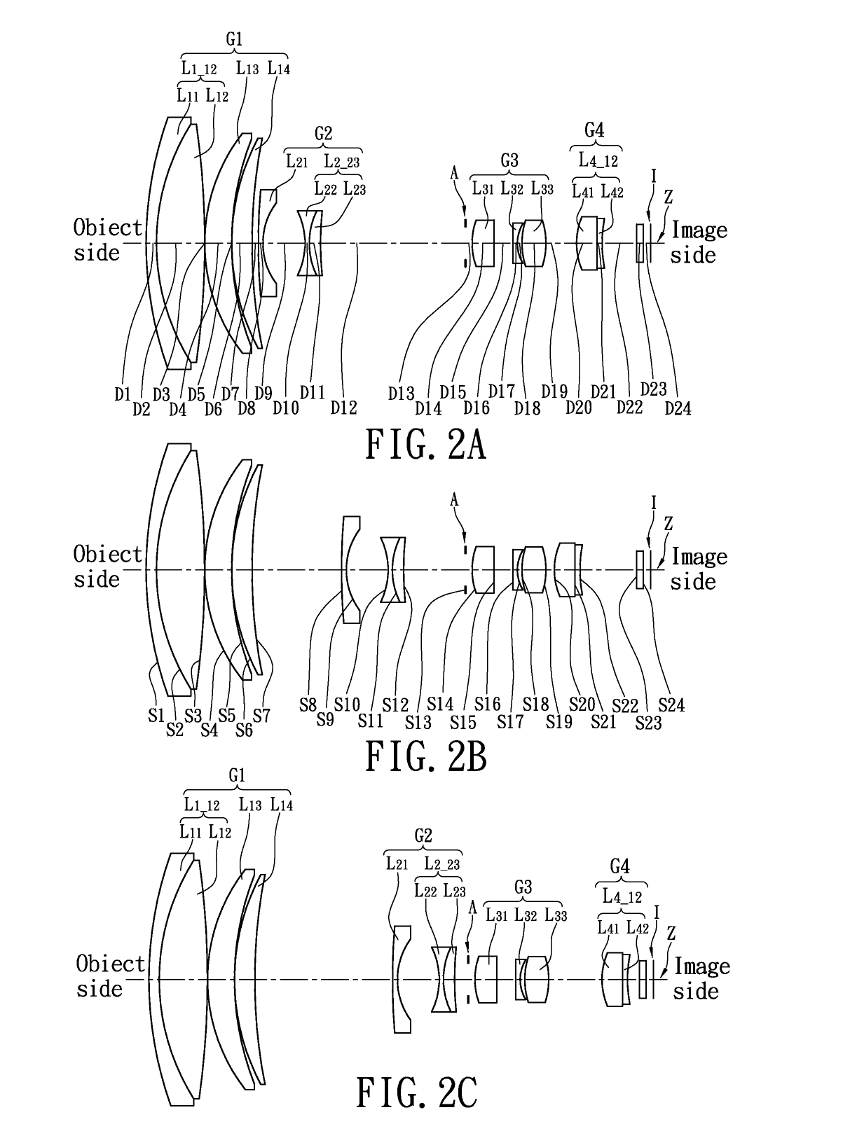

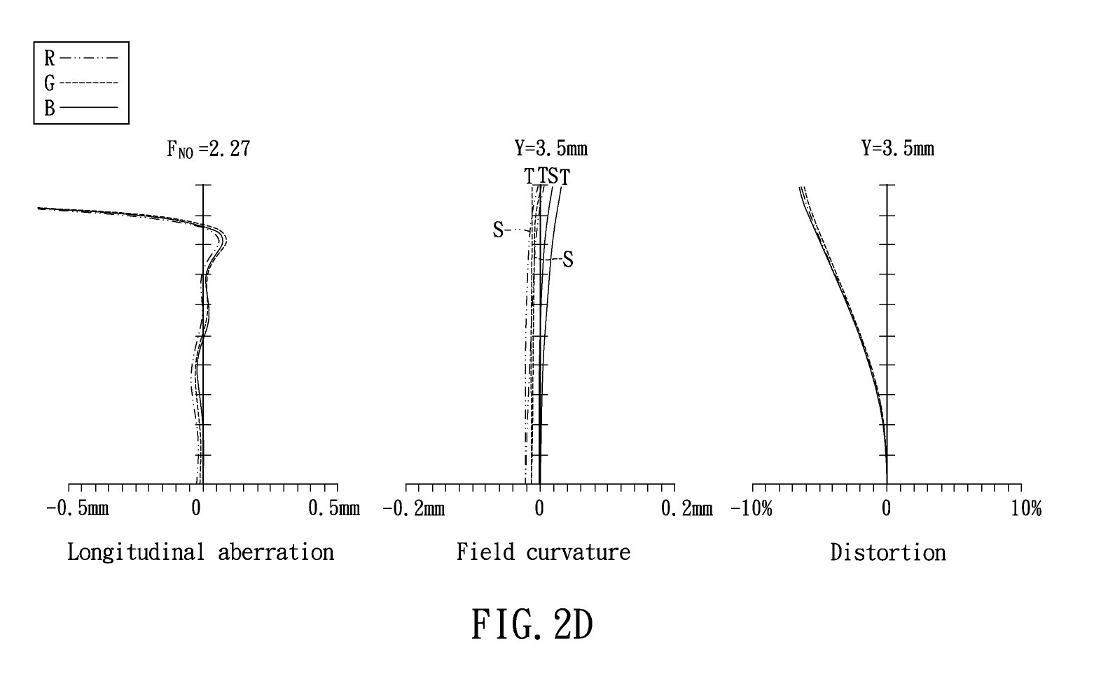

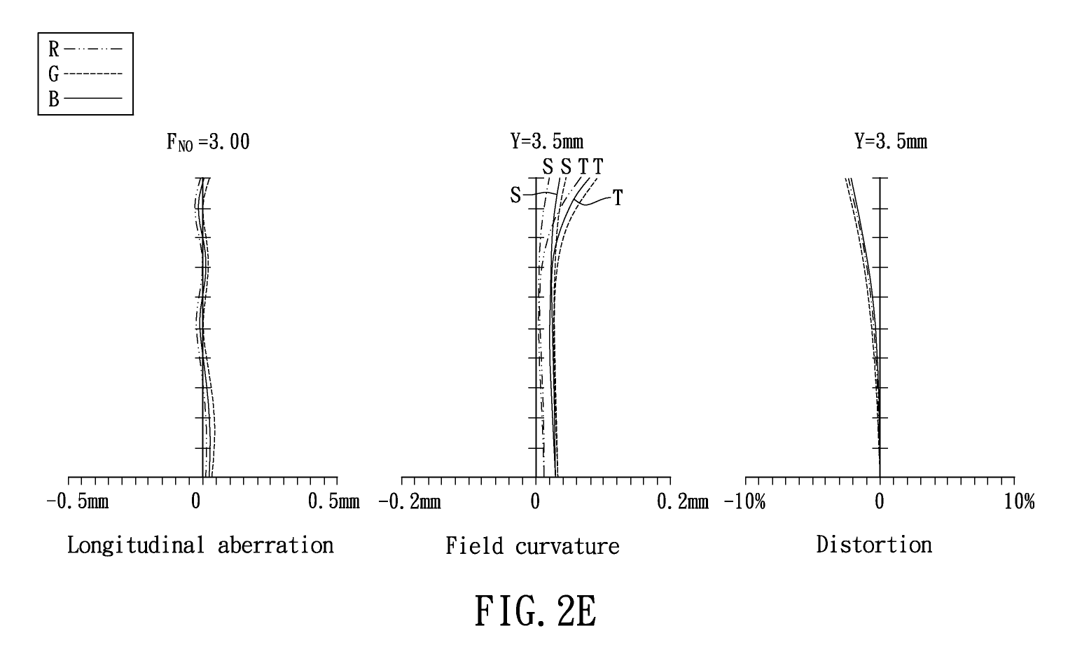

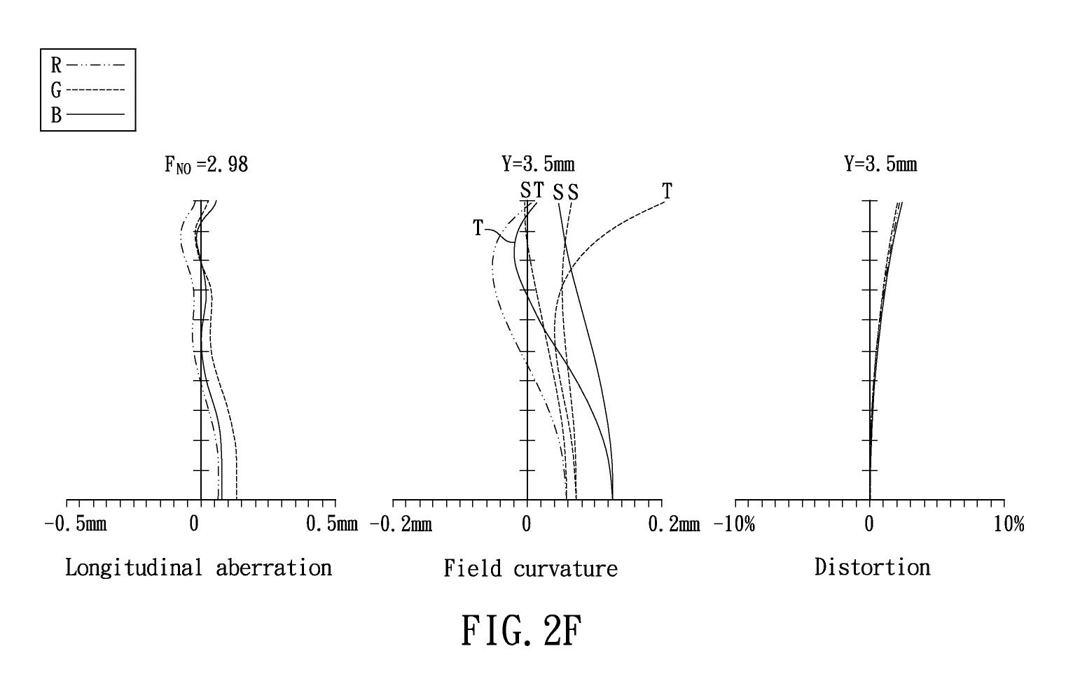

FIGS. 2A to 2C show schematic views of the focal length of the telephoto zoom lens in wide-configuration (FIG. 2A), normal-configuration (FIG. 2B) and tele-configuration (FIG. 2C) according to the second embodiment, respectively. Referring to FIGS. 2D to 2F, where FIG. 2D is a graph showing the longitudinal aberration (left), the field curvature (middle) and the distortion (right) of the telephoto zoom lens, when the focal length of the telephoto zoom lens is in wide-configuration according to the second embodiment, respectively. FIG. 2E is a graph showing the longitudinal aberration (left), the field curvature (middle) and the distortion (right) of the telephoto zoom lens in normal-configuration according to the second embodiment, respectively. FIG. 2F is a graph showing the longitudinal aberration (left), the field curvature (middle) and the distortion (right) of the telephoto zoom lens in tele-configuration according to the second embodiment, respectively.

The simulation data of the second embodiment are shown as the following table:

| | R (mm) | | n_{d} | V_{d} |
|---|---|---|---|---|
| surface | (curvature | D (mm) | (refractive | (Abbe |
| number | radius) | (distance) | index) | number) |
| 1 | 79.53 | 2.44 | 2.00 | 28.3 |
| 2 | 48.74 | 10.00 | 1.50 | 81.5 |
| 3 | −218.78 | 0.20 | | |
| 4 | 38.46 | 6.02 | 1.50 | 81.5 |
| 5 | 64.80 | 0.20 | | |
| 6 | 48.39 | 4.02 | 1.6 | 65.4 |
| 7 | 109.06 | Variable | | |
| 8 | 86.00 | 1.02 | 1.88 | 40.8 |
| 9 | 14.53 | 9.27 | | |
| 10 | −16.74 | 0.91 | 1.73 | 54.7 |
| 11 | 17.69 | 2.64 | 1.92 | 18.9 |
| 12 | 183.98 | Variable | | |
| 13 | Infinity | 1.80 | | |
| 14 | 14.21 | 4.49 | 1.69 | 52.9 |
| 15 | −124.26 | 4.41 | | |
| 16 | 88.39 | 0.97 | 1.85 | 23.8 |
| 17 | 11.15 | 0.56 | | |
| 18 | 23.13 | 4.08 | 1.70 | 55.5 |
| 19 | −60.35 | Variable | | |
| 20 | 14.19 | 4.50 | 1.88 | 40.8 |
| 21 | −32.84 | 0.90 | 1.85 | 23.8 |
| 22 | 35.74 | Variable | | |
| 23 | Infinity | 1.00 | 1.52 | 64.1 |
| 24 | Infinity | 0.80 | | |

The focal length, the aperture value, the view angle and the variable distance D7, D12, D19 and D22 relative to different zoom position are shown as the following table:

| | Wide | Normal | Tele | Unit |
|---|---|---|---|---|
| f | 6.3 | 29 | 121 | mm |
| F_{NO} | 2.27 | 3.00 | 2.98 | |
| FOV(ω) | 29° | 6.8° | 1.65° | |
| D7 | 1.19 | 25.16 | 35.62 | mm |
| D13 | 35.18 | 11.21 | 0.75 | mm |
| D19 | 8.22 | 3.40 | 13.20 | mm |
| D22 | 7.89 | 12.71 | 2.91 | mm |

Where f is the system focal length in wide-configuration, normal-configuration and tele-configuration, F_{NO} is aperture value in wide-configuration, normal-configuration and tele-configuration, and FOV(ω) is view angle in wide-configuration, normal-configuration and tele-configuration.

Moreover, the optical surface S18 and S19 are aspherical surfaces, and the data of the aspherical surfaces are shown as the following table:

| Surface | K | A₄ | A₆ | A₈ | A₁₀ | A₁₂ | A₁₄ | A₁₆ |
|---|---|---|---|---|---|---|---|---|
| S18 | 5.32 | −3.47E−04 | 7.48E−06 | −3.38E−06 | 3.15E−07 | −1.63E−08 | 4.00E−10 | −3.68E−12 |
| S19 | 65.94 | −6.13E−05 | 1.52E−06 | −7.98E−07 | 5.38E−08 | −5.97E−11 | −1.20E−10 | 3.23E−12 |

In addition, the above-mentioned aspherical surfaces in the second embodiment are represented by the same expression as shown in the first embodiment.

In conclusion, the instant disclosure has some advantages, as follows:

1. The instant disclosure can provide an image capturing zoom lens having high zoom ratio, long focal length and high imaging quality.

2. The instant disclosure can create an image capturing zoom lens that has a suitable big aperture diameter of the first lens group and a 20× magnifying power.

The above-mentioned descriptions merely represent the preferred embodiments of the instant disclosure, without any intention or ability to limit the scope of the instant disclosure which is fully described only within the following claims Various equivalent changes, alterations or modifications based on the claims of instant disclosure are all, consequently, viewed as being embraced by the scope of the instant disclosure.

What is claimed is:

1. A telephoto zoom lens, comprising:
a first lens group having a positive refractive power fixed at a first predetermined position;
a second lens group having a negative refractive power being movable along an optical axis of the telephoto zoom lens in accordance with the change of the magnification of the telephoto zoom lens;
a third lens group having a positive refractive power fixed at a second predetermined position; and
a fourth lens group having a positive refractive power being movable along the optical axis in order to keep an image plane generated by the telephoto zoom lens to project accurately onto an image sensor;
wherein the first, the second, the third and the fourth lens groups are arranged along the optical axis and from an object side of the telephoto zoom lens to an image side of the telephoto zoom lens in sequence, and the focal lengths of the first, the second and the third lens groups conform to the two following conditions:
$$6 < \vert \frac{F 1}{F 2} \vert < 10 and 2 < \vert \frac{F 1}{F 3} \vert < 3 ,$$
wherein F1 is the focal length of the first lens group, F2 is the focal length of the second lens group, and F3 is the focal length of the third lens group.

2. The telephoto zoom lens of claim 1, wherein the focal length of the first lens group and the distance from the first lens group to the third lens group conform to the following condition:
$$1 < \vert \frac{F 1}{{d}_{1 - 3}} \vert < 1.2 ,$$
wherein d₁₋₃ is the distance from the first lens group to the third lens group.

3. The telephoto zoom lens of claim 1, wherein the first lens group includes a first lens, a second lens, a third lens and a fourth lens, the first lens and the second lens are combined to form a doublet lens, both the third lens and the fourth lens are a single meniscus lens, the first, the second, the third and the fourth lenses are arranged along the optical axis and from the object side to the image side in sequence, and the focal lengths of the third lens, the fourth lens and the doublet lens conform to the following condition:
$$2 < \vert {F}_{1 \_ 12} \times ( \frac{1}{{F}_{13}} + \frac{1}{{F}_{14}} ) \vert < 4 ,$$
wherein F₁₃ is the focal length of the third lens of the first lens group, F₁₄ is the focal length of the fourth lens of the first lens group, and F₁_{_{—}}₁₂ is the focal length of the doublet lens of the first lens group.

4. The telephoto zoom lens of claim 1, wherein the second lens group includes a first lens, a second lens and a third lens, the first lens is a single lens, the second lens and the third lens are combined to form a doublet lens, the first, the second and the third lenses are arranged along the optical axis and from the object side to the image side in sequence, and the focal lengths of the first lens and the doublet lens conform to the following condition:
$$0.6 < \vert \frac{{F}_{21}}{{F}_{2 - 23}} \vert < 0.8 ,$$
wherein F₂₁ is the focal length of the first lens of the second lens group, and F₂_{_{—}}₂₃ is the focal length of the doublet lens of the second lens group.

5. The telephoto zoom lens of claim 1, wherein the third lens group includes a first lens, a second lens and a third lens, and the first, the second and the third lenses are arranged along the optical axis and from the object side to the image side in sequence, wherein the fourth lens group includes a first lens and a second lens combined to form a doublet lens, and the first lens and the second lens of the fourth lens group are arranged along the optical axis and from the object side to the image side in sequence, and the focal lengths of the third lens group and the fourth lens group conform to the following condition:
$$0.7 < \vert \frac{F 4}{F 3} \vert < 1.2 ,$$
wherein F4 is the focal length of the fourth lens group.

6. A telephoto zoom lens, comprising:
a first lens group having a positive refractive power fixed at a first predetermined position;
a second lens group having a negative refractive power being movable along an optical axis of the telephoto zoom lens in accordance with the change of the magnification of the telephoto zoom lens;
a third lens group having a positive refractive power fixed at a second predetermined position; and
a fourth lens group having a positive refractive power being movable along the optical axis in order to keep an image plane generated by the telephoto zoom lens to project accurately onto an image sensor;
wherein the first lens group includes a first lens, a second lens, a third lens and a fourth lens, the first lens and the second lens are combined to form a doublet lens, both the third lens and the fourth lens are a single meniscus lens, the first, the second, the third and the fourth lenses are arranged along the optical axis and from the object side to the image side in sequence, and the focal lengths of the third lens, the fourth lens and the doublet lens conform to the following condition:
$$2 < \vert {F}_{1 \_ 12} \times ( \frac{1}{{F}_{13}} + \frac{1}{{F}_{14}} ) \vert < 4 ,$$
wherein F₁₃ is the focal length of the third lens of the first lens group, F₁₄ is the focal length of the fourth lens of the first lens group, and F₁_{_{—}}₁₂ is the focal length of the doublet lens of the first lens group.

7. The telephoto zoom lens of claim 6, wherein the first, the second, the third and the fourth lens groups are arranged along the optical axis and from an object side of the telephoto zoom lens to an image side of the telephoto zoom lens in sequence, and the focal lengths of the first, the second and the third lens groups conform to the two following conditions:
$$6 < \vert \frac{F 1}{F 2} \vert < 10 and 2 < \vert \frac{F 1}{F 3} \vert < 3 ,$$
wherein F1 is the focal length of the first lens group, F2 is the focal length of the second lens group, and F3 is the focal length of the third lens group.

8. The telephoto zoom lens of claim 6, wherein the focal length of the first lens group and the distance from the first lens group to the third lens group conform to the following condition:
$$1 < \vert \frac{F 1}{{d}_{1 - 3}} \vert < 1.2 ,$$
wherein F1 is the focal length of the first lens group, and d₁₋₃ is the distance from the first lens group to the third lens group.

9. The telephoto zoom lens of claim 6, wherein the second lens group includes a first lens, a second lens and a third lens, the first lens is a single lens, the second lens and the third lens are combined to form a doublet lens, the first, the second and the third lenses are arranged along the optical axis and from the object side to the image side in sequence, and the focal lengths of the first lens and the doublet lens conform to the following condition:
$$0.6 < \vert \frac{{F}_{21}}{{F}_{2 \_ 23}} \vert < 0.8 ,$$
wherein F₂₁ is the focal length of the first lens of the second lens group, and F₂_{_{—}}₂₃ is the focal length of the doublet lens of the second lens group.

10. The telephoto zoom lens of claim 6, wherein the third lens group includes a first lens, a second lens and a third lens, and the first, the second and the third lenses are arranged along the optical axis and from the object side to the image side in sequence, wherein the fourth lens group includes a first lens and a second lens combined to form a doublet lens, and the first lens and the second lens of the fourth lens group are arranged along the optical axis and from the object side to the image side in sequence, and the focal lengths of the third lens group and the fourth lens group conform to the following condition:
$$0.7 < \vert \frac{F 4}{F 3} \vert < 1.2 ,$$
wherein F3 is the focal length of the third lens group, and F4 is the focal length of the fourth lens group.

11. A telephoto zoom lens, comprising:
a first lens group having a positive refractive power fixed at a first predetermined position;
a second lens group having a negative refractive power being movable along an optical axis of the telephoto zoom lens in accordance with the change of the magnification of the telephoto zoom lens;
a third lens group having a positive refractive power fixed at a second predetermined position; and
a fourth lens group having a positive refractive power being movable along the optical axis in order to keep an image plane generated by the telephoto zoom lens to project accurately onto an image sensor;
wherein the second lens group includes a first lens, a second lens and a third lens, the first lens is a single lens, the second lens and the third lens are combined to form a doublet lens, the first, the second and the third lenses are arranged along the optical axis and from the object side to the image side in sequence, and the focal lengths of the first lens and the doublet lens conform to the following condition:
$$0.6 < \vert \frac{{F}_{21}}{{F}_{2 \_ 23}} \vert < 0.8 ,$$
wherein F₂₁ is the focal length of the first lens of the second lens group, and F₂_{_{—}}₂₃ is the focal length of the doublet lens of the second lens group.

12. The telephoto zoom lens of claim 11, wherein the first, the second, the third and the fourth lens groups are arranged along the optical axis and from an object side of the telephoto zoom lens to an image side of the telephoto zoom lens in sequence, and the focal lengths of the first, the second and the third lens groups conform to the two following conditions:
$$6 < \vert \frac{F 1}{F 2} \vert < 10 and 2 < \vert \frac{F 1}{F 3} \vert < 3 ,$$
wherein F1 is the focal length of the first lens group, F2 is the focal length of the second lens group, and F3 is the focal length of the third lens group.

13. The telephoto zoom lens of claim 11, wherein the focal length of the first lens group and the distance from the first lens group to the third lens group conform to the following condition:
$$1 < \vert \frac{F 1}{{d}_{1 - 3}} \vert < 1.2 ,$$
wherein F1 is the focal length of the first lens group, and d₁₋₃ is the distance from the first lens group to the third lens group.

14. The telephoto zoom lens of claim 11, wherein the first lens group includes a first lens, a second lens, a third lens and a fourth lens, the first lens and the second lens are combined to form a doublet lens, both the third lens and the fourth lens are a single meniscus lens, the first, the second, the third and the fourth lenses are arranged along the optical axis and from the object side to the image side in sequence, and the focal lengths of the third lens, the fourth lens and the doublet lens conform to the following condition:
$$2 < \vert {F}_{1 \_ 12} \times ( \frac{1}{{F}_{13}} + \frac{1}{{F}_{14}} ) \vert < 4 ,$$
wherein F₁₃ is the focal length of the third lens of the first lens group, F₁₄ is the focal length of the fourth lens of the first lens group, and F₁_{_{—}}₁₂ is the focal length of the doublet lens of the first lens group

15. The telephoto zoom lens of claim 11, wherein the third lens group includes a first lens, a second lens and a third lens, and the first, the second and the third lenses are arranged along the optical axis and from the object side to the image side in sequence, wherein the fourth lens group includes a first lens and a second lens combined to form a doublet lens, and the first lens and the second lens of the fourth lens group are arranged along the optical axis and from the object side to the image side in sequence, and the focal lengths of the third lens group and the fourth lens group conform to the following condition:
$$0.7 < \vert \frac{F 4}{F 3} \vert < 1.2 ,$$
wherein F3 is the focal length of the third lens group, and F4 is the focal length of the fourth lens group.
